(19) United States
(12) Patent Application Publication
(10) Pub. No.: US 2013/0259786 A1
(43) Pub. Date: Oct. 3, 2013

(54) APPARATUS AND METHOD FOR THE REMOVAL OF NITROGEN DIOXIDE FROM A FLUE GAS STREAM

(71) Applicants: Erik W. Böös, Vederslov (SE); Wuyin Wang, Vaxjo (SE)

(72) Inventors: Erik W. Böös, Vederslov (SE); Wuyin Wang, Vaxjo (SE)

(73) Assignee: ALSTOM TECHNOLOGY LTD., Baden (CH)

(21) Appl. No.: 13/435,244

(22) Filed: Mar. 30, 2012

(51) Int. Cl. B01D 53/56

(52) U.S. Cl. 423/235; 422/168

(57) ABSTRACT

Disclosed herein is an apparatus comprising an absorption chamber; a flue gas stream inlet, the flue gas stream inlet being operative to dispose a flue gas stream in the absorption chamber, wherein the flue gas stream comprises nitrogen dioxide; an absorbing agent inlet, the absorbing agent inlet being operative to dispose an absorbent agent in the absorption chamber, the absorbing agent comprising an absorbing agent compound and a solvent, wherein the absorbing agent is chemically reactive with nitrogen dioxide to absorb nitrogen dioxide from the flue gas stream, forming a reaction product.

### TECHNICAL FIELD

This disclosure is related to a method and apparatus for the removal of nitrogen dioxide from a flue gas stream. In particular, this disclosure is related to a method and apparatus for the removal of nitrogen dioxide from a flue gas stream produced by the combustion of fuel, where the nitrogen dioxide is removed from the flue gas stream in a gas processing unit or prior to carbon dioxide capture in a carbon capture system.

### BACKGROUND

The combustion of a fuel, such as coal, oil, natural gas, peat, waste, and the like, in a combustion plant such as a power plant, generates a hot process gas stream known as a flue gas stream. In general, the flue gas stream contains particulates and gaseous contaminants such as carbon dioxide (CO₂), nitrogen oxides (NOₓ) such as nitric oxide (NO) and nitrogen dioxide (NO₂), nitrous oxide (N₂O) and sulfur dioxide (SO₂). The negative environmental effects of releasing these gaseous contaminants into the atmosphere have been recognized, and have resulted in the development of processes adapted for removing or reducing the amount of such gaseous contaminants from the flue gas streams.

Various combustion modification techniques have been developed to control the formation of NOₓ in flue gas streams. These techniques generally have relatively low NOₓ reduction efficiencies and involve significant heat loss. Flue gas stream treatment technologies can achieve significantly higher removal efficiencies than combustion modification techniques. Such flue gas treatment technologies include selective catalytic reduction (SCR) and selective non-catalytic reduction (SNCR). SCR and SNCR technologies utilize ammonia or urea to carry out chemical redox reactions to reduce NOₓ to nitrogen (N₂) and water (H₂O). However, significant drawbacks are associated with these technologies, such as high costs, catalyst degradation, ammonia slip and facility space in the case of SCR and a narrow temperature window and ammonia slip (unreacted ammonia) in the case of SNCR. Scrubbing systems which chemically absorb NOₓ from a flue gas stream offer an alternative to SCR and SNCR technologies and their associated drawbacks.

Another system and process is directed to removing or reducing the amount of CO₂ in a flue gas stream by utilizing amine-containing solutions to absorb and capture the CO₂. Amine-containing solutions can efficiently remove CO₂, as well as other contaminants, such as sulfur dioxide and hydrogen chloride, from a flue gas stream. Treatment of the flue gas stream with amine-containing solutions results in an effluent stream that may be regenerated and recirculated throughout the system. However, the presence of contaminants such as NOₓ in the flue gas stream may cause or contribute to the degradation of the amines in the amine-containing solutions and is a precursor for nitrosamines. The degradation products produced by the reactions between the amine-containing solution and the contaminants present in the flue gas stream should be removed as they impact the ability and the effectiveness of the regenerated and recirculated amine-containing solutions to absorb CO₂. In addition, the negative environmental effects of releasing degradation products such as nitrosamines into the atmosphere have also been recognized.

To safeguard the efficiency of the carbon capture system, to comply with emission standards, and to overcome the drawbacks associated with SCR and SNCR technologies, reduction or removal of nitrogen dioxide from the flue gas stream in a gas processing unit or prior to carbon dioxide capture is desired.

### SUMMARY

Disclosed herein is an apparatus comprising an absorption chamber; a flue gas stream inlet, the flue gas stream inlet being operative to dispose a flue gas stream in the absorption chamber, wherein the flue gas stream comprises nitrogen dioxide; an absorbing agent inlet, the absorbing agent inlet being operative to dispose an absorbent agent in the absorption chamber, the absorbing agent comprising an absorbing agent compound and a solvent, wherein the absorbing agent is chemically reactive with nitrogen dioxide to absorb nitrogen dioxide from the flue gas stream, forming a reaction product.

Disclosed herein too is a method comprising contacting a flue gas stream comprising nitrogen dioxide with an absorbing agent comprising an absorbing agent compound and a solvent, wherein the absorbing agent is chemically reactive with nitrogen dioxide to absorb nitrogen dioxide from the flue gas stream; forming a reaction product comprising the absorbing agent and nitrogen dioxide; and separating the reaction product from the flue gas stream.

### BRIEF DESCRIPTION OF THE FIGURES

FIG. 1 is a depiction of an exemplary apparatus that is used to remove nitrogen dioxide from a flue gas stream.

### DETAILED DESCRIPTION

Disclosed herein are an apparatus and a method for removing nitrogen dioxide from a flue gas stream. The apparatus advantageously comprises an absorption chamber, a flue gas stream inlet, and an absorbing agent inlet. The absorbing agent and the flue gas stream are disposed in the absorption chamber, where the absorbing agent chemically reacts with nitrogen dioxide in the flue gas stream to produce a reaction product, whereby the amount of nitrogen dioxide present in the flue gas stream is reduced.

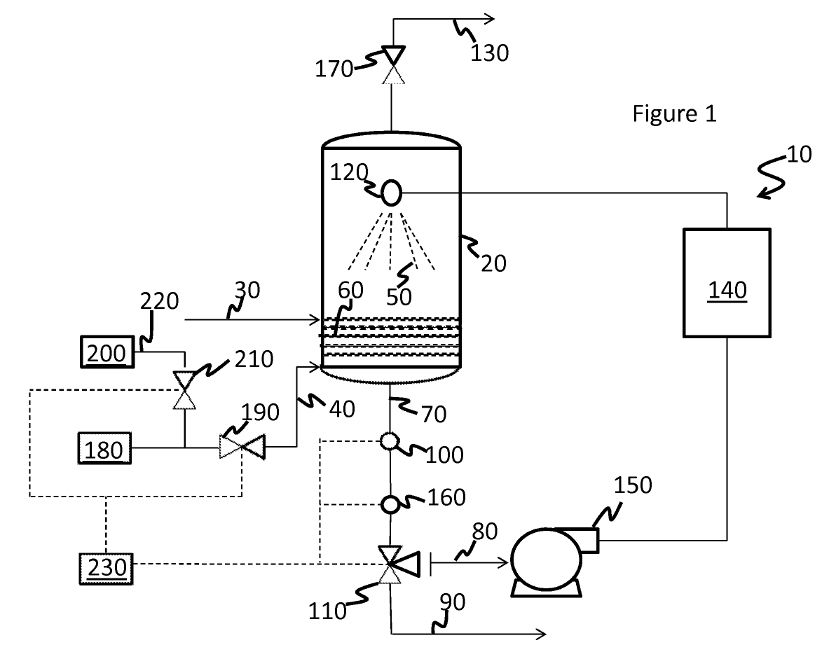

FIG. 1 discloses an embodiment in which the apparatus 10 comprises an absorption chamber 20, a flue gas stream inlet 30 and an absorbing agent inlet 40. A flue gas stream 50 produced from the combustion of fuel and comprising nitrogen dioxide (NO₂) is disposed in the absorption chamber 20 via the flue gas stream inlet 30. The apparatus 10 further comprises an absorbing agent supply chamber 180 disposed upstream of the absorption chamber 20 and in operative communication with the absorbing agent inlet 40. The absorbing agent 60 is disposed in the absorption chamber 20 from the absorbing agent supply chamber 180 via the absorbing agent inlet 40. A first valve 190 is disposed in the absorbing agent inlet 40, the valve being operative to supply the absorbing agent 60 to the absorption chamber 20 via the absorbing agent inlet 40 when it is in an open position. The absorbing agent 60 upon contact with the flue gas stream, is chemically reactive with nitrogen oxides to absorb nitrogen oxides present in the flue gas stream 50, and thereby the amount of nitrogen dioxide in the flue gas stream 50, released from the absorption chamber 20 via the flue gas stream outlet 130, is reduced. A second valve 170 disposed in the flue gas stream outlet 130 is operative to dispose the flue gas stream 50 in the flue gas stream outlet 130 when the second valve 170 is in an open position. In an embodiment, the absorbing agent typically has a pH of less than 9. In one embodiment, the second valve 170 permits the flow of the flue gas stream 50 from the absorption chamber 20 when the absorbing agent 60 contains the desired amount of an absorbing agent compound (e.g., nitrogen oxides such as NOₓ).

The apparatus 10 further comprises an absorbing agent outlet 70, comprising a recirculation conduit 80 and a bleed stream conduit 90. The absorbing agent outlet 70 further comprises a sensor 100, comprising a first concentration sensor, and third valve 110. The third valve 110 is a three-way valve operative to dispose the absorbing agent 60 from the absorbing agent outlet 70 to the recirculation conduit 80 for recirculation or to the bleed stream conduit 90. The absorbing agent 60, now comprising the unreacted absorbing agent, an absorbing agent-NO₂ reaction product, or both, is discharged from the lower region of the absorption chamber 20 via the absorbing agent outlet 70 where the first concentration sensor measures the concentration of absorbing agent compound in the absorbing agent and recirculates the absorbing agent via the recirculation conduit 80 to an area within the upper region of the absorption chamber via a spray head 120. The absorbing agent 60 is discharged from the spray head 120 where the absorbing agent is further contacted with the flue gas stream as the flue gas rises to the upper region of the absorption chamber 20. Although the absorption chamber is depicted in FIG. 1 as an open spray-type absorption chamber, in another embodiment, the absorption chamber 20 is a packed column-type absorption chamber (not shown).

In an embodiment, a pump 150 is used to pump the absorbing agent 60 (now partially saturated with the absorbing agent compound—nitrogen oxides) through the recirculation conduit 80. In another embodiment, a second (optional) concentration sensor (not shown) is disposed in the recirculation conduit 80 or a third (optional) concentration sensor (not shown) is disposed in the absorbing agent inlet 40, or both, and measures the concentration of the absorbing agent compound in the absorbing agent 60.

In an embodiment, the absorbing agent outlet 70 comprises a pH sensor 160. In another embodiment, the absorbing agent inlet 40 comprises a second pH sensor (not shown) to measure the pH of the absorbing agent 60. In yet another embodiment, the sensor 100 further comprises a pH sensor to measure the pH of the absorbing agent 60.

The absorbing agent 60 is repeatedly cycled through the absorption chamber 20 via the recirculation conduit 80 until the first concentration sensor of sensor 100 measures a desired concentration of the absorbing agent compound in the absorbing agent 60 in the absorbing agent outlet 70 or the recirculation conduit 80. The amount of NO₂ absorbed by the absorbing agent 60 is controlled by adjusting the concentration of the absorbing agent 60, or the pH of the absorbing agent 60, or both. The absorbing agent-NO₂ reaction product is discharged from the absorption chamber 20 via the absorbing agent outlet 70 and diverted to the bleed stream conduit 90 via the first valve 110. At the end of the desired number of cycles, the flue gas stream is discharged from the absorption chamber 20 via the flue gas stream outlet 130.

After the absorbing agent-NO₂ reaction product is discharged from the absorption chamber 20 via the absorbing agent outlet 70 and the bleed stream conduit 90, the absorbing agent-NO₂ reaction product is disposed and treated elsewhere.

In an embodiment, the apparatus 10 is disposed in a gas processing unit (GPU), downstream of a combustion chamber from which a flue gas stream is emitted. In another embodiment, the apparatus 10 is disposed upstream of a carbon capture system (CCS), wherein nitrogen dioxide is partially, substantially or completely removed from a flue gas stream prior to processing of the flue gas stream in the carbon capture system. In another embodiment, the apparatus 10 is combined with an intercooler and used in a GPU. In yet another embodiment, the apparatus 10 is disposed in or combined with a direct contact cooler (DCC), upstream of a CCS.

Although the position of the absorbing agent inlet 40 is illustrated in FIG. 1 as being operative to initially dispose the absorbing agent 60 in a lower region of the absorption chamber 20, the location or region where the absorbing agent inlet 40 is positioned is not limited thereto. In another embodiment, the absorbing agent inlet 40 is operative to initially dispose the absorbing agent 60 in the upper region of the absorption chamber 20 or in the recirculation conduit 80, which supplies the absorbing agent 60 to the absorption chamber via the spray head 120. In yet another embodiment, the absorbing agent inlet 40 is operative to dispose the absorbing agent 60 in any region or location in the absorption chamber 20 or any location in the recirculation conduit 80, which supplies the absorbing agent 60 to the absorption chamber 20.

In yet another embodiment (not shown), the apparatus 10 further comprises one or more absorbing agent supply chambers and conduits, pH agent supply chambers and conduits, absorbing agent inlet pumps, absorbing agent concentration sensors, recirculation pumps, NOₓ concentration sensors, pH meters, flow meters, air supply chambers, fans, rotameters, mixing chambers, control processing units, absorbing agent inlets, air inlets, spray nozzles, valves, or the like, or a combination thereof, disposed in or in fluid communication with the apparatus 10.

In an embodiment, the flue gas stream 50 is actively cooled and the absorbing agent 60 is condensed in the absorption chamber 20. In an embodiment, the recirculation conduit 80 (optionally) further comprises a heat exchanger 140 to cool the absorbing agent 60 or absorbing agent-NO₂ reaction product, or both, during recirculation to the absorption chamber 20. In another embodiment, the absorption chamber 20 (optionally) further comprises a cooling unit (not shown) which actively cools the absorbing agent 60 in the absorption chamber 20. In another embodiment, the apparatus 10 comprises one or more pH sensors to measure the pH of the absorbing agent 60 in the absorbing agent inlet 40, the absorbing agent outlet 70, or the recirculation conduit 80, or a combination comprising at least two of the foregoing. In yet another embodiment, the apparatus 10 comprises at least one NO₂ concentration sensor, at least one absorbing agent concentration sensor and at least one pH sensor.

The flue gas stream 50 is produced by the combustion of a fuel, such as coal, natural gas, oil, peat, waste, and the like, in a combustion plant such as a power plant. The flue gas stream 50 comprises particulates and gaseous contaminants such as carbon dioxide (CO₂), nitrogen oxides (NOₓ) such as nitric oxide (NO) and nitrogen dioxide (NO₂), nitrous oxide (N₂O) and sulfur dioxide (SO₂). In an embodiment, the flue gas stream comprises about 0% to about 0.2% by volume nitrogen dioxide, specifically, about 0.00001% to about 0.02%, more specifically, about 0.00001% to about 0.01%, based on the total volume of the flue gas stream 50.

The absorbing agent 60 comprises an aqueous solution of an absorbing agent compound. In an embodiment, the absorbing agent 60 comprises an absorbing agent compound and a solvent. In a specific embodiment, the solvent is water. Examples of suitable absorbing agent compounds include sulfides, sulfites, bi-sulfites, thiosulfates or a combination comprising at least one of the foregoing. In a specific embodiment, the absorbing agent compound is selected from the group consisting of metal sulfides, metal sulfites, metal bi-sulfites, metal thiosulfates or a combination comprising at least one of the foregoing. In an embodiment, the metal is a transition metal comprising sodium, calcium, potassium, magnesium, or the like, or a combination comprising at least one of the foregoing. Suitable examples of the absorbing agent compound include sodium sulfide (Na₂S), sodium sulfite (Na₂SO₃), sodium bi-sulfite (NaHSO₃), sodium thiosulfate (Na₂S₂O₃) or a combination comprising at least one of the foregoing.

In an embodiment, the absorbing agent 60 (optionally) further comprises a pH agent. In one embodiment, the apparatus 10 further comprises a pH agent supply chamber 200 disposed downstream of the absorbing agent supply chamber 180. The pH agent supply chamber 200 supplies the pH agent (not shown) from the pH agent supply chamber 200 to the absorbing agent inlet 40 via a pH agent conduit 220. A fourth valve 210 is disposed in the pH agent conduit 220 which is operative to supply the pH agent from the pH agent supply chamber 200 to the absorbing agent inlet 40 when the fourth valve 210 is in an open position. Although the pH agent supply chamber 200, pH agent conduit 220 and fourth valve 210 are illustrated as being disposed downstream of the absorbing agent supply chamber 180 and upstream of the first valve 190 in FIG. 1, in an embodiment, the pH agent supply chamber 200, pH agent conduit 220 and fourth valve 210 can be downstream of the first valve 190. In another embodiment, the pH agent is disposed directly into the absorbing agent supply chamber 180 from the pH agent supply chamber 200.

In an embodiment, the absorption of NO₂ from the flue gas stream 50 by the absorbing agent 60 is controlled by the pH agent and the associated pH range. The pH agent also selectively controls the absorption of NO₂ from the flue gas stream 50 by the absorbing agent 60 by favoring NO₂ absorption and preventing or reducing the absorption of CO₂ or other contaminants in the flue gas stream by the absorbing agent 60. The pH agent further provides a suitable window for the efficient removal, or absorption, of NO₂ from the flue gas stream 50 in the absorption chamber 20. The pH agent adjusts the pH of the aqueous absorbing agent to a pH typically of less than 9, specifically less than about 7, more specifically between about 5 and about 7, and even more specifically between about 5.5 and about 7. In an embodiment, the pH agent is an alkaline, or basic, material such as a metal hydroxide. In an embodiment, the metal is a transition metal. Examples of suitable transition metals include selected sodium, calcium, potassium, magnesium, or the like, or a combination comprising at least one of the foregoing. In a specific embodiment, the pH agent is sodium hydroxide (NaOH). In another embodiment, the pH agent is an acid. A suitable example of a pH agent that is an acid is sulfuric acid.

In an embodiment, the apparatus 10 further comprises a controller, or control processing unit, 230 in operative communication with the concentration sensor 100, the first valve 190, the second valve 170, the third valve 110, the pH sensor 160 and (optionally, if present) the fourth valve 210 and second pH sensor. In one embodiment, the controller 230 is in electrical communication with the concentration sensor 100, the first valve 190, the second valve 170, the third valve 110, the pH sensor 160 and (optionally, if present) the fourth valve 210 and second pH sensor. In particular, the controller 230 receives an input from the concentration sensor 100 and the pH sensor 160 and provides an output according thereto which directs the opening and closing of the third valve 110 and the second valve 170. The controller 230 is operative to open and close the first valve 190 to supply the desired amount of absorbing agent 60 from the absorbing agent supply chamber 180 to the absorption chamber 20 via the absorbing agent inlet 40. Similarly, if present, the controller 230 is operative to open the fourth valve 210 to supply the pH agent from the pH agent supply chamber 200 to the absorption chamber via the pH agent conduit 220 and the absorbing agent inlet 40. The controller 230 is also operative to close the first valve 190 once the desired amount of absorbing agent 60 has been supplied to the absorption chamber 20, and to close the fourth valve 210 when addition of the pH agent is not desired. The controller 230 is also operative to monitor the concentration sensor 100 and to add additional absorbing agent 60 to the absorption chamber 20 when adjustment of the concentration of the absorbing agent 60 is desired. The controller 230 is also operative to monitor the pH sensor 160 and to add the pH agent as desired. The controller is also operative to control the third, three-way, valve 110 to open the valve to recirculate the absorbing agent from the absorbing agent outlet 70 to the recirculation conduit 80 until the desired number of cycles result in the desired concentration input from concentration sensor 100. At that time, the controller 230 is operative to switch the third, three-way valve, 110 to supply the (NO₂-rich) absorbing agent 60 to the bleed stream conduit 90, and to open the second valve 170 to allow the (scrubbed) flue gas stream 50 to exit the absorption chamber 20 via the flue gas stream outlet 130.

In an embodiment, the absorbing agent 60 further comprises an absorbing agent additive which enhances the capacity of nitrogen dioxide absorbed by the absorbing agent. Examples of suitable absorbing agent additives include an amine, an oxidation additive, or a combination comprising at least one of the foregoing. In an embodiment, the absorbing agent additive is triethylenediamine (C₆H₁₂N₂). The oxidation additive converts NO in the gas flue stream 50 to NO₂, e.g., 2NO+2O₂2NO₂). Examples of suitable oxidation additives include ozone (O₃), chlorine dioxide (ClO₂), chlorine (Cl₂), sodium chlorite (NaClO₂), hydrogen peroxide (H₂O₂), sodium hypochlorite (NaClO) or a combination comprising at least one of the foregoing. In an embodiment, NO in the flue gas stream is oxidized to NO₂ in the absorption chamber 20 by the oxidation additive prior to absorption of NO₂ in the flue gas stream by the absorbing agent compound, the absorbing agent additive, or a combination thereof In a specific embodiment, the absorbing agent comprises an absorbing agent compound, triethylenediamine and an oxidizing agent.

The flow rate of the flue gas and absorbing agent, the concentration of the absorbing agent compound and absorbing agent additives in the absorbing agent, the liquid/gas ratio, pressure and temperature and retention time (or flue gas stream-absorbing agent contacting time) in the apparatus 10 are selected to selectively reduce the amount of NO₂ present in the flue gas stream 50 as desired. In an embodiment, the concentration of NO₂ reaches an equilibrium between the amount of NO₂ in the flue gas stream 50 and the amount of NO₂ absorbed by the aqueous absorbing agent 60. In one embodiment, the retention time of the aqueous absorbing agent in the absorption chamber is between about 1 to about 600 seconds, specifically about 4 to about 500 seconds, more specifically about 10 to about 500 seconds. In another embodiment, the contact time of the aqueous absorbing agent and the flue gas stream in the upper region of the absorption chamber with regard to gas residence time is between about 0 to about 5 seconds, specifically about 0.5 to about 4 seconds, more specifically about 1 to about 3 seconds. In a pressurized system, the retention time for the flue gas in the absorption chamber is a function of the pressure, for example about 5 to about 200 seconds.

In an embodiment, the combined concentration of the absorbing agent compound, absorbing agent additive and (optional) pH agent in the aqueous absorbing agent 60 is about up to 100 g/l, specifically about up to 50 g/l, more specifically about up to 10 g/l the recirculation conduit 80. In another embodiment, the combined concentration of the absorbing agent compound, absorbing agent additive and (optional) pH agent in the aqueous absorbing agent 60 is about up to 1 g/l, specifically about up to 0.5 g/l, more specifically about up to 0.3 gain the recirculation conduit 80. In a specific embodiment, the apparatus 10 is used in a gas processing unit, such as an oxygen (oxy) gas processing unit, and the combined concentration of the absorbing agent compound, absorbing agent additive and (optional) pH agent in the aqueous absorbing agent 60 is up to about 20 g/l, specifically about 1-10 g/l. In another specific embodiment, the apparatus 10 is used upstream of a carbon capture system (a CO₂ absorbing system), and the combined concentration of the absorbing agent compound, absorbing agent additive and (optional) pH agent in the aqueous absorbing agent 60 is up to about 1000 mg/l, specifically about 1 to about 500 mg/l, more specifically about 1 to about 300 mg/l.

In another embodiment, the concentration of nitrogen dioxide in the flue gas stream 50 prior to entering the apparatus 10 is about 1 to about 2000 ppmv, specifically about 1 to about 1000 ppmv, more specifically, about 10 to about 400 ppmv. In yet another embodiment, the concentration of nitrogen dioxide in the flue gas stream 50 after cycling through the apparatus 10, and upon exiting the flue gas outlet 130, is about 1 to about 20 ppmv, specifically about 1 to about 10 ppmv, more specifically, about 1 to about 5 ppmv. In a specific embodiment, the apparatus 10 is used in a gas processing unit, such as an oxygen (oxy) gas processing unit, and the concentration of nitrogen dioxide in the flue gas stream 50 prior to entering the apparatus 10 is about 1 to about 1000 ppmv, specifically about 1 about 700 ppmv, more specifically about 1 to about 500 ppmv. In another specific embodiment, the apparatus 10 is used upstream of a carbon capture system (a CO₂ absorbing system), and the concentration of nitrogen dioxide in the flue gas stream 50 prior to entering the apparatus 10 is about 1 to about 10 ppmv, specifically about 1 to about 5 ppmv.

In an embodiment, the absolute pressure in the absorption chamber 20 is from about 0 bar to about 35 bars. In a specific embodiment, nitrogen dioxide is absorbed and removed from the flue gas stream 50 under low pressure, wherein the pressure in the absorption chamber 20 is from about 1 bar to about 10 bars, specifically about 1 to about 5 bars, more specifically about 1 to about 2 bars, at a temperature between about 0 to about 50 degrees Celsius. In another specific embodiment, nitrogen dioxide is absorbed and removed from the flue gas stream 50 under medium or high pressure, wherein the pressure in the absorption chamber 20 is from about 10 bar to about 35 bars, specifically about 15 to about 35 bars, more specifically about 25 to about 35 bars, at a temperature between about 0 to about 100 degrees Celsius. In a specific embodiment, the apparatus 10 is used in a gas processing unit, such as an oxygen (oxy) gas processing unit, and the absolute pressure in the absorption chamber is 20 is about 2 to about 35 bars. In another specific embodiment, the apparatus 10 is used upstream of a carbon capture system (a CO₂ absorbing system), and the absolute pressure in the absorption chamber is 20 is about 1 bar. The retention time in the absorption chamber 20 is proportional to the pressure. In an embodiment, the retention time in the absorption chamber 20 under high pressure increases proportionally with the pressure, provided the size of the absorption chamber 20 remains constant.

In an embodiment, the amount of NO₂ in the flue gas stream 50 is reduced by about 50 vol % to about 95 vol %, specifically about 60 vol % to about 90 vol %, more specifically about 70 vol % to about 80 vol %. In one embodiment, the amount of NO₂ in the flue gas stream 50 is reduced by about 65 vol %. In another embodiment, the amount of NO₂ in the flue gas stream 50 is reduced by about 75 vol %. In yet another embodiment, the amount of NO₂ in the flue gas stream 50 is reduced by about 85 vol %. %. In still yet another embodiment, the amount of NO₂ in the flue gas stream 50 is reduced by about 90 vol %. In a further embodiment, the amount of NO₂ in the flue gas stream 50 is reduced by about 95 vol %.

Disclosed herein too is a method comprising contacting a flue gas stream comprising nitrogen dioxide with an absorbing agent comprising an absorbing agent compound and a solvent, wherein the absorbing agent has a pH<9 and is chemically reactive with nitrogen oxides to reduce nitrogen dioxide from the flue gas stream; forming a reaction product comprising the absorbing agent and nitrogen dioxide; and separating the reaction product from the flue gas stream.

The apparatus and method disclosed herein advantageously use the concentration of the absorbing agent and/or the pH of the absorbing agent to control the targeted absorption of NO₂ from a flue gas stream. The apparatus and method provide a suitable window during for efficient and cost-effective removal of NO₂ from a flue gas stream. The apparatus and method occupy low facility space, significantly decrease the amount NO₂ released into the atmosphere, and prevent amine degradation and formation of nitrosamines in downstream contaminant absorbers such as a CCS, and subsequent reduced amine replacement.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term and/or is used herein to mean both “and” as well as “or”. For example, “A and/or B” is construed to mean A, B or A and B.

The transition term “comprising” is inclusive of the transition terms “consisting essentially of” and “consisting of” and can be interchanged for “comprising”.

While this disclosure describes exemplary embodiments, it will be understood by those skilled in the art that various changes can be made and equivalents can be substituted for elements thereof without departing from the scope of the disclosed embodiments. In addition, many modifications can be made to adapt a particular situation or material to the teachings of this disclosure without departing from the essential scope thereof. Therefore, it is intended that this disclosure not be limited to the particular embodiment disclosed as the best mode contemplated for carrying out this disclosure.

1. An apparatus comprising:
an absorption chamber;
a flue gas stream inlet, the flue gas stream inlet being operative to dispose a flue gas stream in the absorption chamber, wherein the flue gas stream comprises nitrogen dioxide;
an absorbing agent inlet, the absorbing agent inlet being operative to dispose an absorbent agent in the absorption chamber, the absorbing agent comprising an absorbing agent compound and a solvent, wherein the absorbing agent is chemically reactive with nitrogen dioxide to absorb nitrogen dioxide from the flue gas stream, forming a reaction product.

2. The apparatus of claim 1, wherein the absorbing agent compound comprises a metal sulfide, a metal sulfite, a metal bi-sulfite, a metal thiosulfate or a combination comprising at least one of the foregoing.

3. The apparatus of claim 1, wherein the absorbing agent further comprises a pH agent, further wherein the absorbing agent, comprising the absorbing agent compound, the solvent and the pH agent, has a pH<9.

4. The apparatus of claim 3, wherein the pH agent is a metal hydroxide or sulfuric acid.

5. The apparatus of claim 1, wherein the absorption chamber is in a gas processing unit or upstream of a carbon capture system.

6. The apparatus of claim 1, wherein the absorbing agent further comprises an absorbing agent additive.

7. The apparatus of claim 1, wherein the absorbing agent is recirculated in the absorption chamber to further contact the flue gas stream.

8. The apparatus of claim 1, wherein the amount of nitrogen dioxide in flue gas stream is reduced by about 50 vol % to about 95 vol %.

9. The apparatus of claim 1, wherein the retention time during which the nitrogen dioxide from the flue gas stream is contacted with the absorbing agent in the absorption chamber is about 1 to about 600 seconds.

10. The apparatus of claim 1, wherein the absolute pressure in the absorption chamber is about 1 bar to about 35 bars.

11. A method comprising:
contacting a flue gas stream comprising nitrogen dioxide with an absorbing agent comprising an absorbing agent compound, an oxidation additive, and a solvent, wherein the absorbing agent is chemically reactive with nitrogen dioxide to absorb nitrogen dioxide from the flue gas stream; to convert nitrogen oxide to nitrogen dioxide;
forming a reaction product comprising the absorbing agent and nitrogen dioxide; and
separating the reaction product from the flue gas stream.

12. The method of claim 11, wherein the absorbing agent compound comprises a metal sulfide, a metal sulfite, a metal bi-sulfite, a metal thiosulfate or a combination comprising at least one of the foregoing.

13. The method of claim 11, wherein the absorbing agent further comprises a pH agent, further wherein the absorbing agent, comprising the absorbing agent compound, the solvent and the pH agent, has a pH<9.

14. The method of claim 13, wherein the pH agent is a metal hydroxide or sulfuric acid.

15. The method of claim 11, wherein the contacting the flue gas stream comprising nitrogen dioxide with an absorbing agent is in a gas processing unit or upstream of a carbon capture system.

16. (canceled)

17. The method of claim 11, further comprising recirculating the absorbing agent to further contact the flue gas stream.

18. The method of claim 11, wherein the amount of nitrogen dioxide in flue gas stream is reduced by about 50 vol % to about 95 vol %.

19. The method of claim 11, wherein the contacting the flue gas stream comprising nitrogen dioxide with the absorbing agent occurs over a duration of time of about 1 to about 600 seconds.

20. The method of claim 11, wherein the contacting the flue gas stream comprising nitrogen dioxide with the absorbing agent occurs at an absolute pressure of about 1 bar to about 35 bars.

21. The method of claim 10, where the oxidation additive comprises ozone, chlorine dioxide, chlorine, sodium chlorite, hydrogen peroxide, sodium hypochlorite, or a combination comprising at least one of the foregoing oxidation additives.
